(19) United States
(12) Patent Application Publication
(10) Pub. No.: US 2011/0154622 A1
(43) Pub. Date: Jun. 30, 2011

(54) Slide Fastener with Decorative Members and Method for Manufacturing Thereof

(75) Inventors: Giuseppe Odone, Desana-VC (IT); Simona Casolaro, Praraolo (Vercelli) (IT); Marco Colombo, Vercelli (IT)

(73) Assignee: YKK Corporation, Tokyo (JP)

(21) Appl. No.: 12/977,119

(22) Filed: Dec. 23, 2010

(30) Foreign Application Priority Data
Dec. 24, 2009 (IT) TO2009A001040

(51) Int. Cl. A44B 19/08; B29D 5/00

(52) U.S. Cl. 24/403; 29/408

(57) ABSTRACT

A slide fastener is provided. Each of two adjacent stringers includes a fastener tape which has outer and inner longitudinal edge portions and an intermediate portion between the outer and inner longitudinal edge portions and carries respective coupling elements provided in the fastener tape. Each stringer is provided with a plurality of decorative beads. The decorative members are provided on an outside surface of the fastener tape and the coupling elements are provided on an inside surface of the fastener tape. The decorative members are affixed to the outside surface of the fastener tape in which the intermediate portion is formed.

The disclosure of Italian Patent Application No. TO2009A001040 file on Dec. 24, 2009, including specification, drawings and claims are incorporated herein by reference in its entirety.

### BACKGROUND

The present invention relates to a slide fastener or a zipper provided with decorative members such as decorative beads or stones.

More specifically, the present invention concerns a slide fastener comprising two adjacent stringers, each including a flexible fastener tape having outer and inner longitudinal edge portions and an intermediate portion therebetween and carrying coupling means provided in each fastener tape, each stringer being provided with a respective plurality of decorative members.

For example, U.S. Pat. No. 5,511,292 and U.S. Pat. No. 5,588,185 disclose a slide fastener or a zipper of this type.

The slide fastener described in those references comprises stringers with plastic injection moulded teeth on fastener tapes. Decorative beads or decorative stones, for instance lead crystal beads, are moulded in the upper surfaces of the coupling teeth at the same time when the coupling teeth is injection moulded on the fastener tapes.

With such slide fasteners, the beads or the stones incorporated in the coupling teeth may be damaged in use by the open or close operation of the slider of the fastener. Furthermore; in said slide fasteners of the prior art, the beads or the stones which have been damaged or injured in use of clothing for many years are likely to become noticeable or become lusterless.

### SUMMARY

An object of at least one embodiment of the present invention is to provide a slide fastener in which decorative members such as decorative beads or stones, which are protruded from a fastener tape are hard to be damaged or injured in use of the slide fastener.

In order to achieve at least one of the above objects, according to an aspect of at least one embodiment of the present invention, there is provided a slide fastener wherein an inner edge portion of each fastener tape is bent into a U shape and turned to a rear face at an inner side of each fastener tape, and a continuous coil element which forms a coupling teeth is affixed to an outside face of the fastener tape which is bent into the U shape. In use of the slide fastener in a clothing, the coupling teeth arranged in a rear face at an inner side of each fastener tape is less visible from a side of an outside surface of the fastener tape. A plurality of decorative members such as decorative beads or stones, are affixed to the outside surface of each fastener tape. In a presently preferred embodiment, said beads are affixed to a surface of each fastener tape by means of an adhesive layer.

In another aspect of at least one embodiment, said beads are carried by each support tape which is affixed to the outside surface in which an intermediate portion of each fastener tape is formed.

The invention also relates to a method for manufacturing slide fasteners in which a plurality of decorative members such as decorative beads and stones are affixed to a surface of a fastener tape, according to the abovementioned embodiment.

According to a slide fastener with decorative members and a manufacturing method thereof in the present invention, it is possible to prevent the decorative members such as decorative beads or stones, which are protruded from a fastener tape from being damaged or injured due to the open or close operation of the slide fastener.

### BRIEF DESCRIPTION OF DRAWINGS

Further features and advantages of the present invention will become apparent from the following detailed description, with reference to the accompanying drawings, provided merely by way of nonlimitative example, wherein:

FIG. 1 is a front plan view of a portion of a slide fastener according to the present invention;

FIG. 2 is a side view of the slide fastener shown in FIG. 1; and

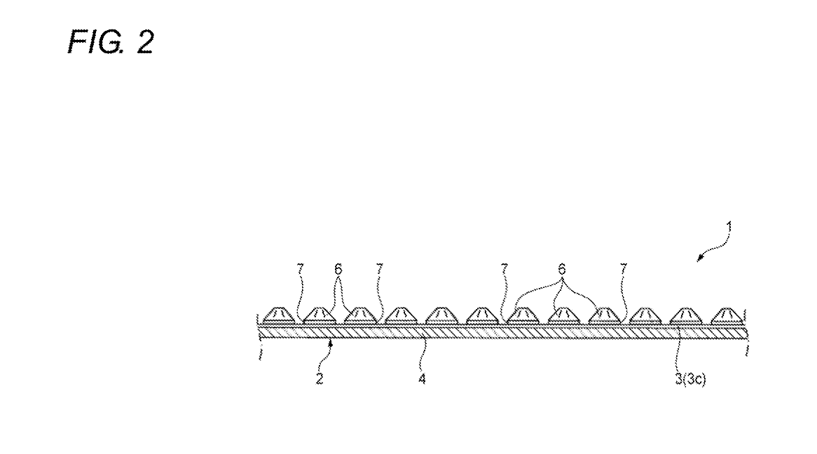

FIG. 3 is a cross-sectional view, showing a phase or step of a method for the manufacture of the slide fastener according to FIGS. 1 and 2;

FIG. 4 is a cross-sectional view, taken along line IV-IV of FIG. 1;

FIG. 5 is a front plan view of another slide fastener according to the present invention;

FIG. 6 is a side view of the slide fastener shown in FIG. 5; and

FIG. 7 is a cross-sectional view, taken along line VII-VII of FIG. 5.

### DETAILED DESCRIPTION OF EMBODIMENTS

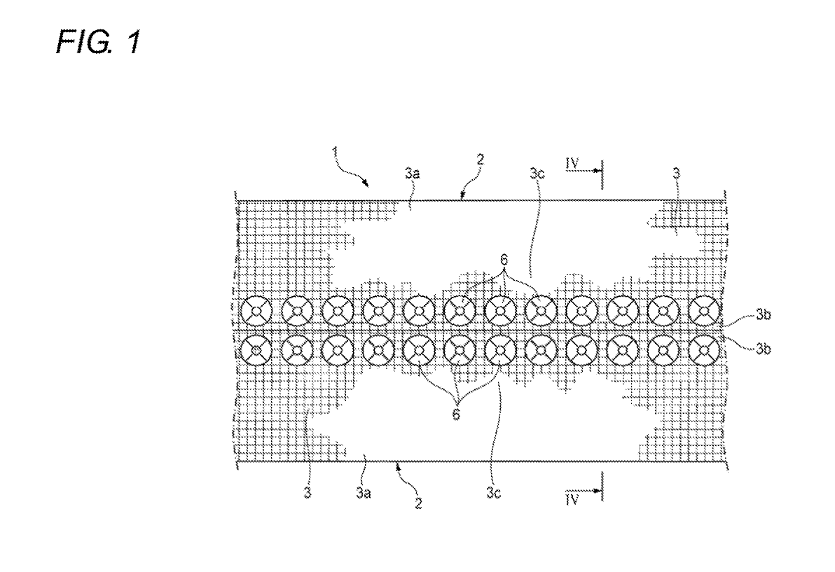

With reference to FIG. 1, a slide fastener 1 according to an embodiment of the present invention comprises two confronting stringers 2, including a pair of flexible fastener tapes 3 which are made for instance of a fabric such as a knitted fabric or a woven fabric.

In the slide fastener 1, the fastener tapes 3 are hard to be separated from each other and a coupling teeth (fastener element) 4 provided in an inside surface which is a rear side or rear surface of each fastener tapes 3 is less visible even when a load or a tensile force is applied to the fastener tapes 3. “CONCEAL” which is a kind of slide fastener in which the fastener element 4 is less visible from an outside surface which is front surface of each fastener tape 3 is a registered trademark of YKK Corporation.

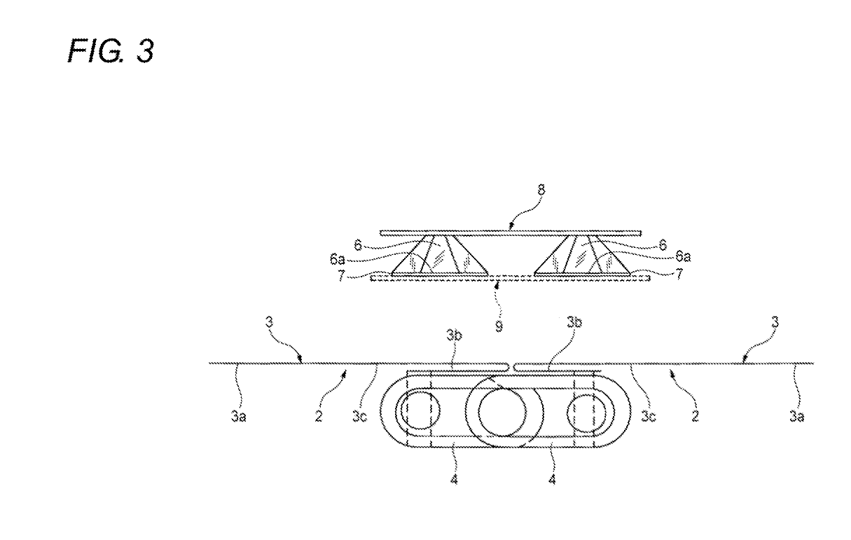

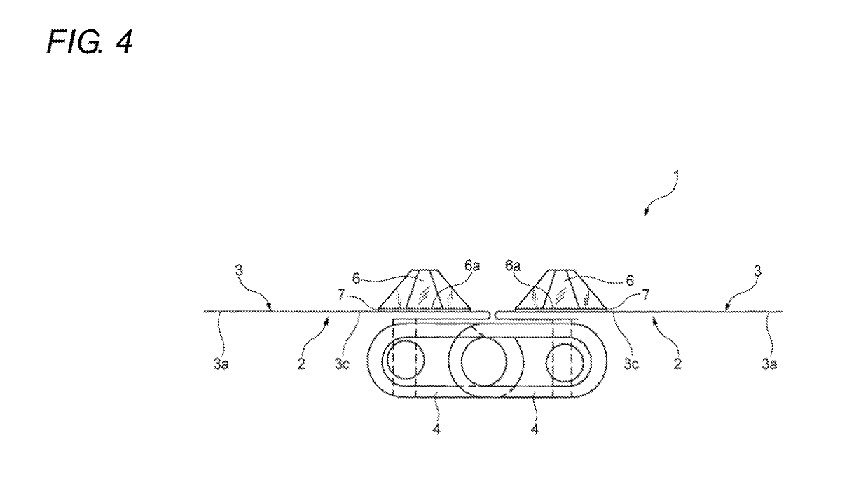

Each fastener tape 3 has an outer edge portion 3a which is to be sewn to a clothing and the like along a longitudinal direction of the fastener tape 3, an inner edge portion 3b, and an intermediate portion 3c between the outer edge portion 3a and the inner edge portion 3b (see in particular FIGS. 3 and 4).

The inner edge portion 3b of each fastener tape 3 is bent into a U shape and turned inside, and a coil element 4 which is the coupling teeth continued along the longitudinal direction of the fastener tape 3 is affixed to the outside face of the fastener tape 3 bent into the U shape. That is, the coil element 4 is provided in the rear surface which is the inside surface of the fastener tape 3. The coupling teeth 4 provided in the rear surface of the fastener tape 3 is not limited to the coil element 4. For example, a resin element may be injection moulded onto the fastener tape 3 and provided along the longitudinal direction of the fastener tape 3 with a gap therebetween. A metal element may also be provided along the longitudinal direction of the fastener tape 3 with a gap therebetween.

A plurality of decorative beads 6 such as lead crystal beads, are affixed to the outside surface of the fastener tape 3 in which the intermediate portion 3c of each fastener tape 3 is formed. That is, the decorative beads 6 are provided in a surface which is outer side of each fastener tape 3. The decorative beads 6 or decorative stone 6 which is decorative members 6 may be a decorative glass (crystal glass) which has clarity and optical refraction index to glow red, blue or achroma and which is made for example of a lead glass in which lead oxide is added to a main component of a glass, such as potassium or calcined soda, or a nonlead crystal glass in which a titanium compound or the other chemical compound is added to a glass. Generally, a glass in which the percentage of the lead oxide with respect to the entire glass exceeds 24 percent is referred to as a lead crystal.

The arrangement is such that when a slider which is not shown slides and the fastener is closed, as shown in FIG. 1, the fastener elements 4 engages with each other and the decorative beads 6 on the fastener tapes 3 extend adjacent one another to form a row along the longitudinal direction of the fastener tapes 3.

Preferably, each of the decorative beads is arranged in the longitudinal row along the longitudinal direction of at least one of the fastener tapes 3.

The decorative beads 6 arranged in one of the fastener tapes 3 can be longitudinally staggered with respect to the decorative beads 6 arranged in another one of the fastener tapes 3.

The decorative beads 6 are affixed to the outside surface in which the intermediate portion 3c of each fastener tape 3 is formed by means of an adhesive layer 7. The decorative beads 6 are arranged not only in the longitudinal row along, the longitudinal direction of the fastener tapes 3, but also in a curved row or to form various shapes constituting characters, symbols, a graphic or a pattern on the outside surface of the fastener tape 3.

In a presently preferred manufacturing process, for example as shown in FIG. 3, when the decorative beads 3 which are arranged right and left so as to correspond to each fastener tape 3 at right and left sides or are arranged in the outside surface along the longitudinal direction of the fastener tape 3 are affixed to the fastener tapes 3, at least one carrier tape 8 (see FIG. 3), for instance a commercially available paper carrier tape 8 is removably applied to upper surfaces of the decorative beads 6, by means of a releasable adhesive. Each bead 6 is provided, on a lower surface 6a of each decorative beads 6 facing away from the carrier tape 8, with a respective strong adhesive layer 7 (see FIGS. 3 and 4).

The decorative beads 6 are applied to the outside surface of the fastener tape 3, in which the intermediate portions 3c of the fastener tapes 3 is formed, while being kept in their relative positions by the carrier tape 8. Once the decorative beads 6 have been attached to the fastener tapes 3, the carrier tape 8 is removed. In FIG. 8, one carrier tape 8 is provided on the upper surfaces of the decorative beads 6 to be affixed to each of the right-and-left fastener tape 3. The number, the length and the shape of the carrier tapes 8 may be changed in accordance with the arrangement of decorative beads 6 in various shapes constituting a curved line, characters, symbols, a graphic or a pattern formed on the outside surface of each fastener tape 3.

A protective, detachable cover tape 9 (shown in phantom in FIG. 3) can be provided on the adhesive layers 7 of the decorative beads 6, to be removed therefrom just before the decorative beads 6, carried by the carrier tape 8, are applied to the fastener tapes 3.

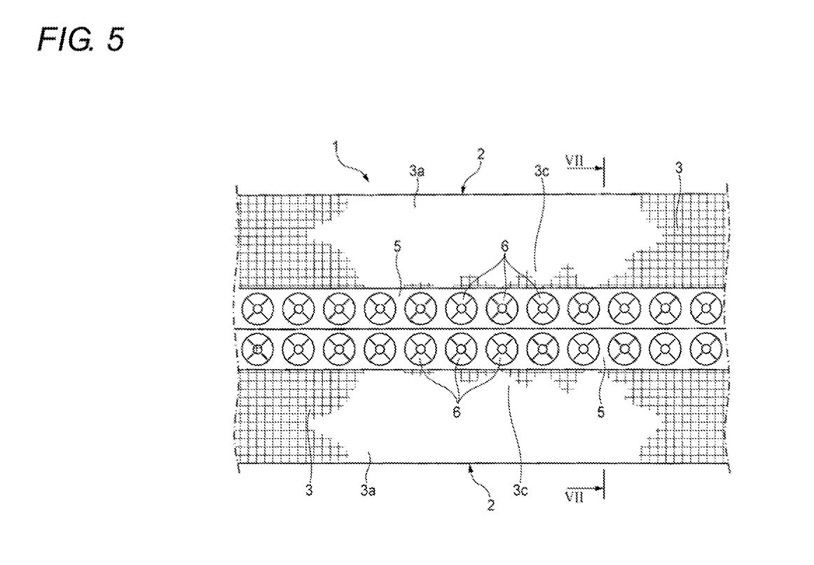

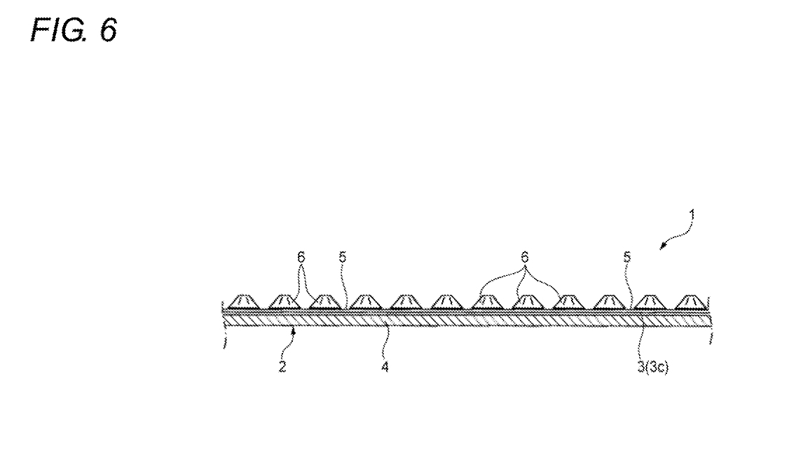

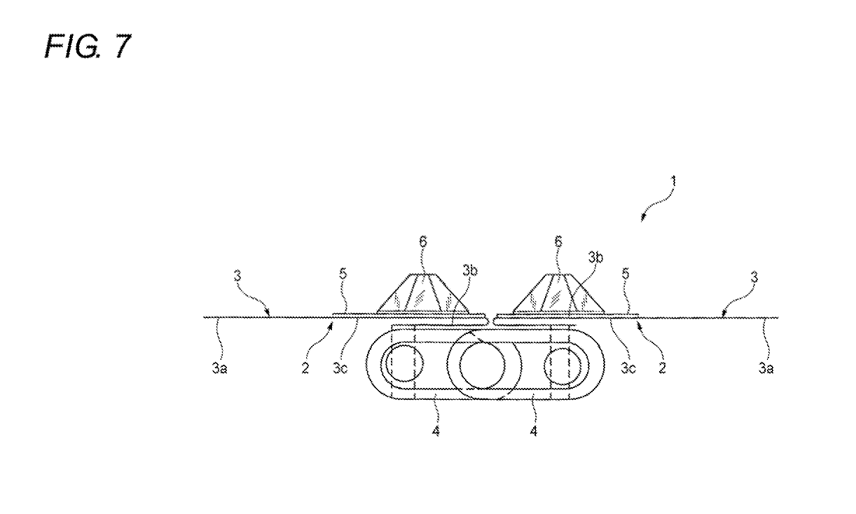

In another embodiment, shown in FIGS. 5 to 7, a respective support tape 5 permanently carrying a plurality of decorative beads 6 is affixed to the outside surface of the fastener tape 3, in which the intermediate portion 3c of each fastener tape 3 is formed.

The arrangement is such that when the fastener 1 is closed, as shown in FIG. 5, the support tapes 5 extend adjacent one another to form a row along the longitudinal direction of the fastener tapes 3.

The support tapes 5 are preferably of the thermally weldable type, and are thermally applied to the outside surfaces of the fastener tapes 3, in which the intermediate portions 3c of the respective fasteners tapes 3 are formed.

The support tapes 5 affixed to the fastener tapes 3 can be manufactured separately from one another, or can be obtained by cutting a single tape provided with two sets of the decorative beads 6. Such a tape can be cut before or after being applied to the tapes 3 of the slide fastener. The number, the length, the shape of support tapes 5 may be changed in accordance with the arrangement of decorative beads 6 in various shapes constituting a curved line, characters, symbols, a graphic or a pattern formed on the outside surface of each fastener tape 3.

In a slide fastener 1 according to the embodiments of the present invention, the decorative beads 6 cannot be damaged by the slider used for engaging/disengaging the fastener elements 4 of the stringers 2.

Furthermore, in the slide fastener 1 according to the embodiments of the present invention, the slider and the fastener elements 4 are provided on the rear surface of the fastener tapes 3, and as shown in FIGS. 1 and 3, since there is almost no gap between the inner sides of the respective stringers 2 facing one another, the slider and the fastener elements 4 are almost invisible from the outside surfaces of the fastener tapes 3 in its condition of use.

Naturally, the principle of the invention remaining the same, the embodiments and details of construction can be widely varied with respect to what has been described and illustrated purely by way of non-limitative example, without thereby departing from the scope of the invention as defined in the annexed claims.

1. A slide fastener, comprising two adjacent stringers, each including a fastener tape which has outer and inner longitudinal edge portions and an intermediate portion between the outer and inner longitudinal edge portions and carrying respective coupling elements provided in the fastener tape, each stringer being provided with a plurality of decorative members,
wherein the decorative members are provided on an outside surface of the fastener tape and the coupling elements are provided on an inside surface of the fastener tape, and
wherein the decorative beads are affixed to the outside surface of the fastener tape in which the intermediate portion is formed.

2. The slide fastener according to claim 1,
wherein the coupling elements arranged in the inside surface of the fastener tape to couple the stringers are fastener elements, and
wherein the inner edge portion of the fastener tape is bent into a U shape and turned to the inside surface of the fastener tape, and the fastener elements are attached to an outer surface of the fastener tape which is bent into the U shape.

3. The slide fastener according to claim 1, wherein the decorative members are affixed to the intermediate portion of the fastener tape by means of an adhesive layer.

4. The slide fastener according to claim 1, wherein the decorative members are carried by a support tape which is affixed to the outside surface of the intermediate portion of the fastener tape.

5. The slide fastener according to claim 4, wherein the support tape is a thermally weldable tape, which is to be thermally applied to the fastener tape.

6. The slide fastener according to claim 4, wherein the support tape carries at least one longitudinal row of decorative members.

7. The slide fastener according to claim 1, wherein the decorative members are arranged such that when the slide fastener is closed the decorative members extend adjacent one another.

8. The slide fastener according to claim 1, wherein each of the decorative members are made of a decorative glass or a crystal glass.

9. A method for manufacturing the slide fastener according to claim 1, wherein:
the decorative members are removably applied to at least one carrier tape and each of the decorative members is provided with an adhesive layer on a lower surface facing away from the at least one carrier tape, and
the decorative members are applied to the intermediate portions of the fastener tape and, once attached, the at least one carrier tape is removed.

10. The method according to claim 9, wherein a cover tape that protects the adhesive layer is detachably provided on the adhesive layer of the decorative members, and is removed therefrom before the decorative members, carried by the at least one carrier tape, are applied to the fastener tape.
